(19) United States
(12) Patent Application Publication
(10) Pub. No.: US 2016/0350850 A1
(43) Pub. Date: Dec. 1, 2016

(54) SYSTEM AND METHOD FOR SIMULTANEOUS MULTI-OPTION LOAN PRICING AND ADJUDICATION FOR AUTOMOBILES

(71) Applicants: Keith Shields, Austin, TX (US); Samuel Miller, Austin, TX (US)

(72) Inventors: Keith Shields, Austin, TX (US); Samuel Miller, Austin, TX (US)

(21) Appl. No.: 15/163,870

(22) Filed: May 25, 2016

Related U.S. Application Data
(60) Provisional application No. 62/166,469, filed on May 26, 2015.

(51) Int. Cl. G06Q 40/02

(52) U.S. Cl. CPC G06Q 40/025

(57) ABSTRACT

Simultaneous, real-time, multi-option loan pricing and adjudication for automobile consumers is described herein. Through risk-quantification and pricing technology, auto loan contracts are generated on an entire vehicle set of any size for a consumer. Relevant predictive data is obtained about the shopper from credit bureaus, social media, public record, click-thru data, or the like. Based on data retrieved from physical and virtual vehicle lots and personal data of the consumer, a vehicle set of relevant options is provided to the consumer for selection.

### PRIORITY

This application claims the benefit of and priority to U.S. Provisional Patent Application Ser. No. 62/166,469, filed May 26, 2015, which is incorporated herein by this reference in its entirety.

### FIELD OF DISCLOSURE

The present invention relates to loans, such as automobile loans, and, more particularly, a method and system for simultaneous, real-time, multi-option loan pricing and adjudication.

### Background of the Disclosure

In typical circumstances for an automobile purchase, a prospective consumer must engage in a two-step process. More particularly, a consumer must pick a particular car, and then must generally obtain financing to purchase the selected car. Should financing be unavailable to the consumer for the selected car for any of a variety of frequent reasons, such as inadequate credit score, inadequate buying history, or pricing of the car above a level at which credit can be offered to the consumer, by way of non-limiting example, the consumer must pick a different car, and the financing process must be repeated. It goes without saying that this can lead to significant disappointment on the part of the consumer, and extreme inefficiencies in the financing process, particularly in cases where 3, 4 or even 5 vehicles must be selected by the consumer before the consumer is able to obtain financing.

Because of the foregoing, it has been estimated that up to 16% [citation: PwC at 2015 Consumer Bankers Association CBA Live Conference] of all automobile-purchasing consumers select a particular dealer, or a particular car, only because a dealer was able to get them financing on a certain car or cars. In such instances, the first step mentioned above, namely picking a car, is unavailable or limited to the consumer. This, too, will likely serve to disappoint or frustrate a consumer. Further, the consumer in such a circumstance has no ability to know whether he or she could have selected a different car other than the one selected and still obtained the financing—that is, that consumer was drawn to the dealer because the dealer was able to offer financing on a specific vehicle, but even the dealer may not know on which other vehicles the financing, or variations of the financing, could be available. Rather, the dealer has drawn in the consumer under the premise that the financing is available on a specific chosen vehicle. In this case, the availability of financing is a higher order of priority than the consumer's selection of a vehicle, consequently limiting the buying and financing options for the consumer and the selling and financing options for the dealer.

Therefore, the need exists for a system and method of simultaneously offering a prospective consumer at least one loan on multiple different automobiles on either a virtual or literal automobile lot, wherein the terms of the prospective loans are known to both the dealer and the consumer prior to the consumer's selection of a vehicle.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

FIG. 1 is a simplified diagram of the disclosed embodiments;

FIG. 2A is a simplified diagram of the exemplary embodiments;

FIG. 2B is a simplified diagram of the exemplary embodiments;

FIG. 3 is a simplified environment of the exemplary embodiments; and

FIG. 4 is a simplified block diagram of an exemplary computing environment in connection with which at least one embodiment of the system.

### DETAILED DESCRIPTION OF THE DISCLOSED EMBODIMENTS

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

The disclosure is directed to a system and method of simultaneously providing multiple options for financing on multiple automobiles; for tracking said data across multiple automobiles and multiple buyers; for using analytics of said data to affect pricing for financing across multiple financial institutions, multiple loan types, and to adjust criteria for financing across multiple loan types. More particularly, rather than engaging in loan financing as was done in the prior art, namely awaiting a consumer to select an automobile and thereafter calculating financing, if available for that automobile, the disclosed platform determines risk specific to a given consumer for multiple or all automobiles available on a virtual or actual automobile lot. That is, a consumer may receive advanced assessment of available financing for all vehicles across all Toyota® vehicle lots local to the consumer, for all vehicles on E-Bay Motors®, for all vehicles of a specific type, description, or which meet other search criteria across E-Bay Motors®, for all used vehicles of a particular type across 5 used car lots within 15 miles of the consumer, or the like.

As such, the disclosed embodiments may indicate an optimal loan amount, an optimal interest rate, and/or other optimal loan criteria for each car meeting the desired and/or searched criteria for a particular consumer. Correspondingly, loan pricing and loan adjudication may be provided to the consumer in advance, and for multiple vehicles and/or multiple dealers meeting the consumer's criteria, and the terms of the loan may be auto-created for the consumer in advance. Thereby, frustration to the consumer in selecting a vehicle for which financing is later found to be unavailable is avoided through the use of the disclosed embodiments.

Further, the disclosed embodiments may serve to receive consumer information and provide search capabilities, or database listing capabilities, across one or more virtual or actual vehicle lots, may structure optimal loans in advance in accordance with given criteria, may implement consumer and/or vehicle collateral models, and/or may provide networked software hook capabilities for connecting to third party auto loan originations and servicing software. More specifically, the present invention generates at least one literal loan option for each consumer for each vehicle, provided that the required interest rate does not exceed statutory limits. The system does not merely provide a loan estimator or a loan calculator that only provides theoretical loan term values.

Correspondingly, the disclosed embodiments provide consumers greater choice in purchasing a vehicle, while providing tools that make vehicle shopping more intuitive, more targeted, more transparent, and more tailored to a consumer's purchasing capacity. Further, consumers opting in to the use of the disclosed embodiments may rest assured that they have guaranteed (subject to statutory limits) available predetermined financing on a plurality of vehicles responsive to the consumer's wishes.

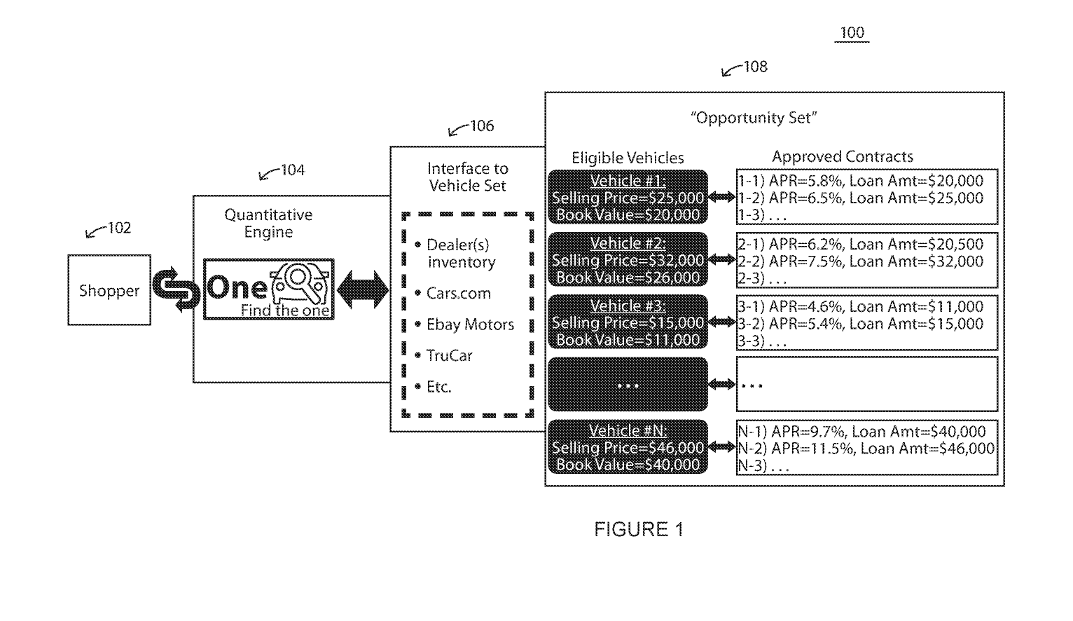

FIG. 1 is a block diagram 100 illustrating aspects of the present invention. As shown, the consumer, or shopper 102, interfaces using a graphical user interface provided by the one or more networked servers of the platform disclosed herein. The consumer is interfaced through the GUI provided by a Quantitative Engine 104 to a vehicle set 106, such as vehicles available on one or more virtual or physical lots, wherein the vehicle set may be limited by search criteria entered by the consumer. Virtual and physical lots may include, but are not limited to, dealer(s) inventory, vehicles listed for sale on internet sites by dealers or private sellers, such as Cars.com®, Ebay Motors®, TruCar®, or the like. Thereafter, the values of the vehicles and the vehicles set may be compared to the consumer's financial information, and loan financing terms, if available, are uniquely matched for that consumer to the vehicles and the vehicle sets available to that consumer. This information is then provided back to the consumer through the GUI, and the consumer may further refine available loans and vehicle sets, and preferred loan terms, such as through entry of additional search criteria, in the GUI. Financing terms may include, for example, purchase price maximum, down payment required, amortization term, interest rate, maximum monthly payment, and the like, as will be understood to those of ordinary skill in the pertinent arts.

As illustrated in FIG. 1, the present platform is customizable, at least in that analytics may be modular, such that credit models related to the consumer, credit information regarding the consumer, depreciation models regarding a vehicle, valuation models regarding a vehicle, and the like, may be customized and/or replaced in the platform on an independent and individualized basis. Accordingly, the system of FIG. 1 provides onboard real time analytics to the platform in relation to both the consumer, the vehicle, and the consumer-vehicle combination, across all consumers, all vehicles, all dealers, and the like that participate in the platform. Thereby, the onboard, customizable, real time predictive analytics of the system of FIG. 1 may be deployed to generate a sensible, fundable, quantitatively derived and definitively available financing option for any vehicle that an individual consumer may choose to select from a given vehicle set. A given vehicle set may be provided using the GUI and shown as an Opportunity Set 108. The Opportunity Set may show multiple eligible vehicles (Vehicle #1, Vehicle #2, Vehicle #3, . . . Vehicle #N) as well as appropriate information (i.e. loan information) for each eligible vehicle.

More particularly, the platform provides sensibility in that the price sensitivities of the consumer's financial background are considered, and reasonability constraints for the consumer's purchasing power may be modularly provided through an analytics module. Moreover, the financing option will be fundable in that risk adjusted return requirements are modularly built into the platform. Thereby, all offers may be structured so that the resulting asset will meet the supporting lenders return targets. Additionally, all offers may be quantitatively derived in that each offer is subjected to predictive analytics that engineer accurate predictions of risk that satisfy the constraints of both the borrower and lender, because they are based on robust behavioral analytics modules for that consumer, that lender, that vehicle, and the like.

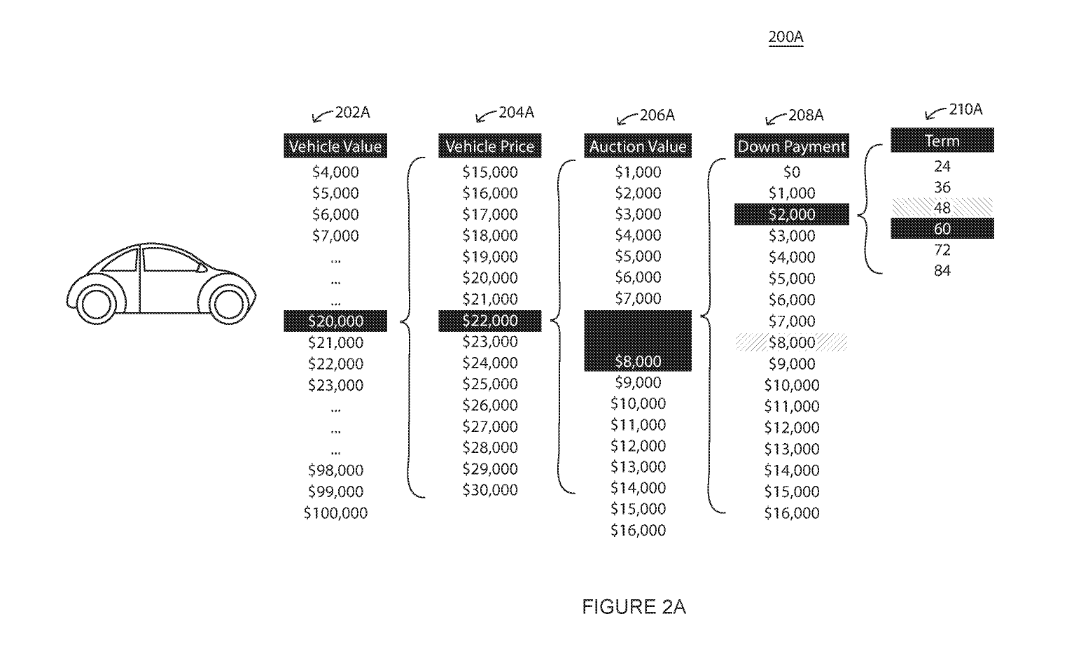

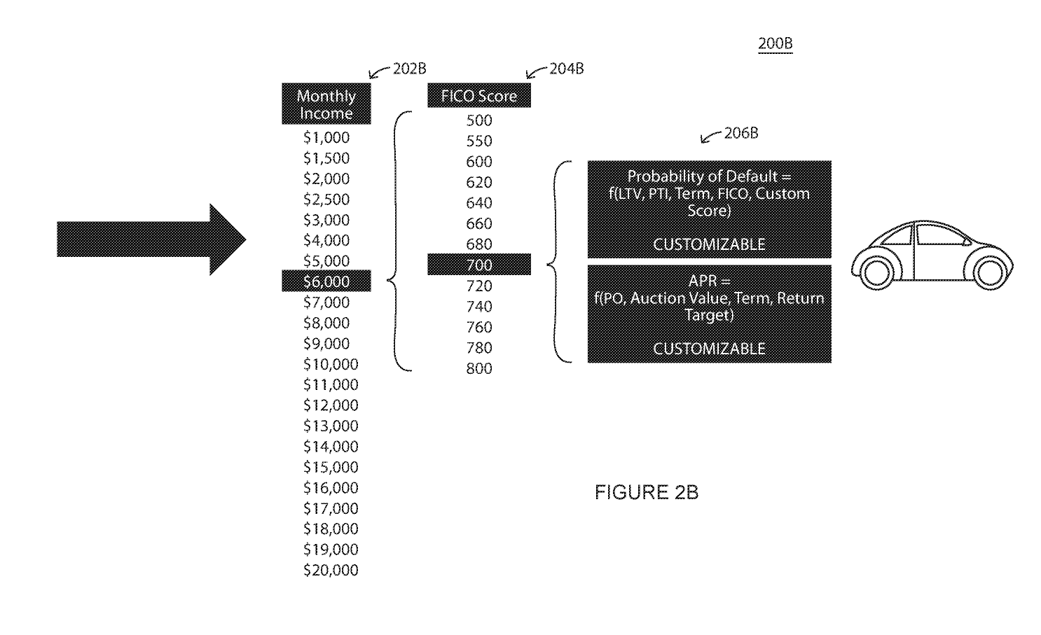

FIG. 2A illustrates a process flow 200A in accordance with the disclosed exemplary embodiments. In the example of FIG. 2A, for simplicity sake, the vehicle set comprises one vehicle. The consumer indicates an interest in loan approval for the single vehicle and the vehicle is matched, by virtue of its presence in the vehicle set, to a plurality of data based tables containing culminations of loan limitations, consumer criteria, and required vehicle attributes. At step 202A, a proprietary analytics module based on actual sales data across dealers and vehicle types generates a precise estimate of vehicle value. At step 204A, the vehicle asking price is pulled from the dealer's vehicle data. At step 206A, the vehicle value and vehicle price are compared to the vehicle auction value, which is provided by an analytics module that has accumulated actual sales data for the particular model of vehicle. The auction value provides the basis for the loss amount given default (LGD) for the desired vehicle.

At step 208A of FIG. 2A, the consumer's down payment amount is entered and/or recommended. At this juncture, the loan amount and loan to value may be calculated. At step 210A, a desired loan term, preferably in months, may be entered by the consumer, or may be indicated by the platform (multiple cases for loan term may be indicated by the platform at this point). At this stage, the consumer's monthly payment for the vehicle set may be known. Further, at this stage, the true vehicle value, total loan amount, loan to value, term, and the monthly payment amount may be known to the platform.

The process continues to FIG. 2B, flow diagram 200B. At step 202B, consumer's supplied data may be used for comparison, such as monthly income of the consumer, in order to assess the consumer's ability to pay particular loan amounts on a monthly basis. At step 204B, a credit score, full credit report, aggregated credit attributes, and alternative data elements for the consumer may be provided. Of note, the credit score may be, for example, a FICO score for the consumer, or may be a proprietary credit score generated by one of the aforementioned analytics modules of the current platform, at least in that the data accumulated for the vehicles, loans, consumers, and defaults across the many loans issued through the present platform allow the platform to produce a more refined credit score for a particular loan purpose than would the generally available credit scores used today. Finally, at step 206B, loan particulars are calculated by the aforementioned analytics modules for comparison to specific lender loan criteria. At this juncture, any lender criteria for a given loan that has been met may make that particular loan available to that particular consumer for that particular vehicle or vehicle set.

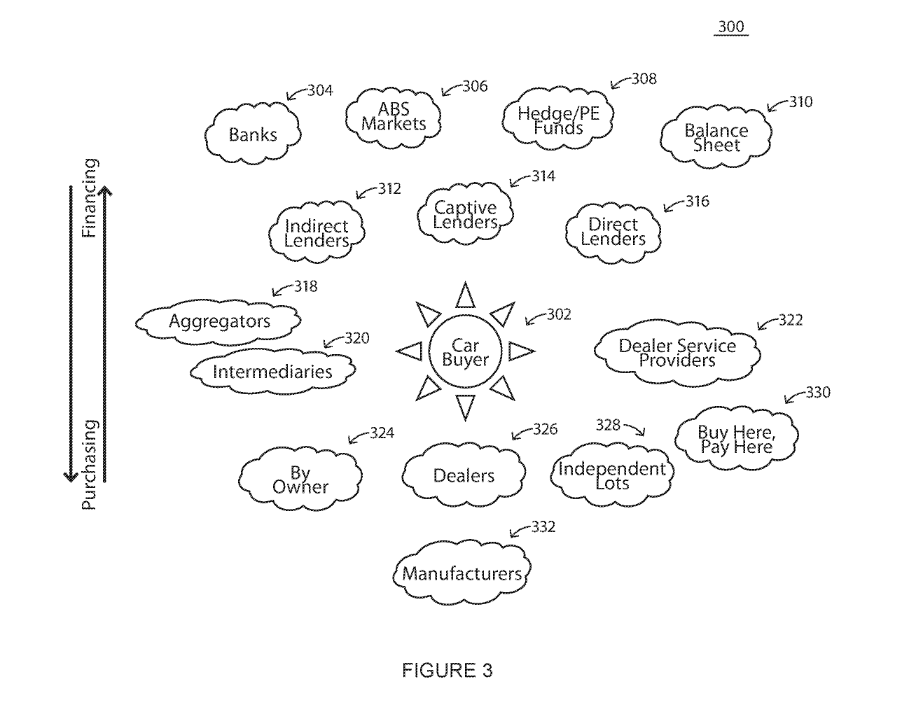

FIG. 3 is an ecosystem diagram 300 illustrating the ecosystem layers serviced by the system and method of FIGS. 1, 2A, and 2B. In the illustration of FIG. 3, the car buyer 302 may interface, directly or indirectly with a plurality of entities to obtain financing and engage in a vehicle purchase. These interactions are provided, directly or indirectly, through the use of the system and method of FIGS. 1, 2A, and 2B. The plurality of entities may include, but are not limited to, Banks 304, ABS Markets 306, Hedge/PE Funds 308, Balance Sheet 310, Indirect Lenders 312, Captive Lenders 314, Direct Lenders 316, Aggregators 318, Intermediaries 320, Dealer Service Providers 322, By Owner 324, Dealers 326, Independent Lots 328, Buy Here, Pay Here 330, and/or Manufacturers 332.

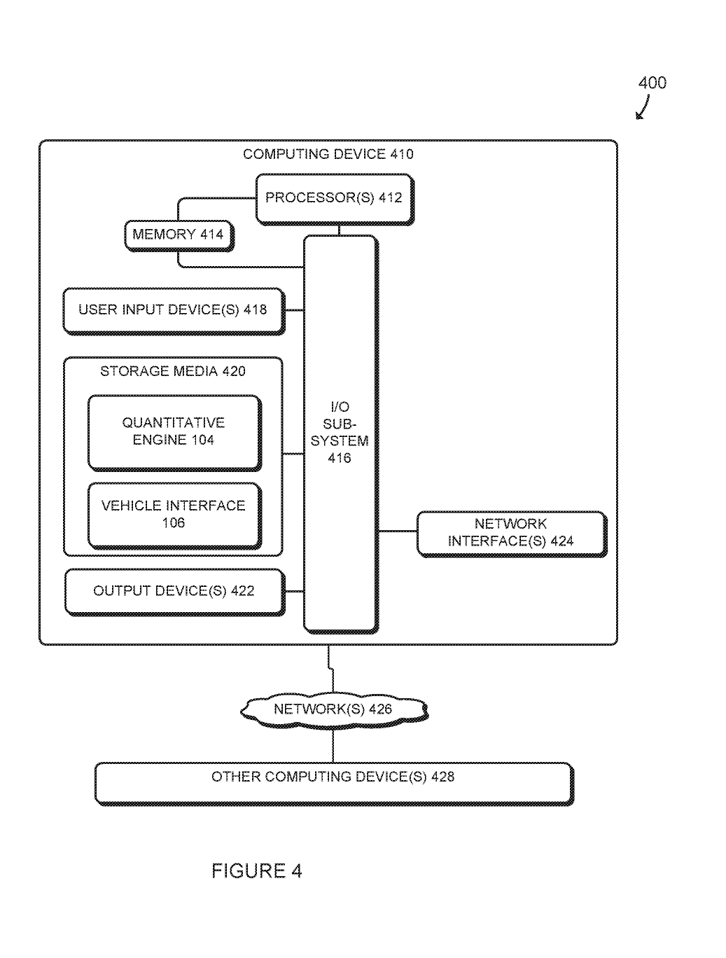

Referring now to FIG. 4, a simplified block diagram of an exemplary computing environment 400 for the computing system 100, Quantitative Engine 104 and Interface to Vehicle Set 106 may be implemented, is shown. The illustrative implementation 400 includes a computing device 410, which may be in communication with one or more other computing systems or devices 428 via one or more networks 426. The computer device 410 may comprise on storage media 420 Quantitative Engine 104 and Interface to Vehicle Set 106.

The illustrative computing device 410 includes at least one processor 412 (e.g. a microprocessor, microcontroller, digital signal processor, etc.), memory 414, and an input/output (I/O) subsystem 416. The computing device 410 may be embodied as any type of computing device such as a personal computer (e.g., a desktop, laptop, tablet, smart phone, wearable or body-mounted device, etc.), a server, an enterprise computer system, a network of computers, a combination of computers and other electronic devices, or other electronic devices. Although not specifically shown, it should be understood that the I/O subsystem 416 typically includes, among other things, an I/O controller, a memory controller, and one or more I/O ports. The processor 412 and the I/O subsystem 416 are communicatively coupled to the memory 414. The memory 414 may be embodied as any type of suitable computer memory device (e.g., volatile memory such as various forms of random access memory).

The I/O subsystem 416 is communicatively coupled to a number of components including one or more user input devices 418 (e.g., a touchscreen, keyboard, virtual keypad, microphone, etc.), one or more storage media 420, one or more output devices 422 (e.g., speakers, LEDs, etc.), and one or more network interfaces 424.

The storage media 420 may include one or more hard drives or other suitable data storage devices (e.g., flash memory, memory cards, memory sticks, and/or others). In some embodiments, portions of systems software (e.g., an operating system, etc.), framework/middleware (e.g., APIs, object libraries, etc.). Portions of systems software or framework/middleware may be copied to the memory 414 during operation of the computing device 410, for faster processing or other reasons.

The one or more network interfaces 424 may communicatively couple the computing device 410 to a network, such as a local area network, wide area network, personal cloud, enterprise cloud, public cloud, and/or the Internet, for example. Accordingly, the network interfaces 424 may include one or more wired or wireless network interface cards or adapters, for example, as may be needed pursuant to the specifications and/or design of the particular computing system 400. The network interface(s) 424 may provide short-range wireless or optical communication capabilities using, e.g., Near Field Communication (NFC), wireless fidelity (Wi-Fi), radio frequency identification (RFID), infrared (IR), or other suitable technology.

The other computing system(s) 428 may be embodied as any suitable type of computing system or device such as any of the aforementioned types of devices or other electronic devices or systems. For example, in some embodiments, the other computing systems 428 may include one or more server computers used to store portions of the Quantitative Engine 104 and/or Vehicle Interface 106. The computing system 400 may include other components, sub-components, and devices not illustrated in FIG. 4 for clarity of the description. In general, the components of the computing system 400 are communicatively coupled as shown in FIG. 4 by electronic signal paths, which may be embodied as any type of wired or wireless signal paths capable of facilitating communication between the respective devices and components.

### General Considerations

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media, which may be read and executed by one or more processors. A machine-readable medium may include any mechanism for storing or transmitting information in a form readable by a machine (e.g., a computing device or a “virtual machine” running on one or more computing devices). For example, a machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided into sub-modules, sub-processes or other units of computer code or data as may be required by a particular design or implementation.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the disclosure.

This disclosure is to be considered as exemplary and not restrictive in character, and all changes and modifications that come within the spirit of the disclosure are desired to be protected.

1. A method for providing a quantitatively-derived financing option for a consumer, the method comprising:
receiving, from the consumer, one or more first parameters;
retrieving, from a third party, one or more second parameters;
analyzing the first parameters based at least in part on the second parameters; and
based on the analyzing, presenting one or more options to the consumer.

2. The method of claim 1, wherein the one or more first parameters comprise personal identifying information associated with the consumer.

3. The method of claim 2, wherein the one or more first parameters comprises a search query.

4. The method of claim 3, wherein the third party is a physical vehicle lot or a virtual vehicle lot.

5. The method of claim 4, wherein the one or more second parameters comprise information associated with the third party.

6. The method of claim 5, wherein the one or more second parameters are retrieved based on the search query.

7. The method of claim 6, wherein the one or more options comprises a vehicle set of one or more automobiles.

8. The method of claim 7, wherein the vehicle set is determined based on a quantitatively derived set of vehicle options based on the one or more first parameters and the one or more second parameters.

9. The method of claim 8, wherein the quantitatively derived set of vehicle options is determined using real time predictive analytics.

10. The method of claim 9, wherein the vehicle set is displayed to the consumer on a graphical user interface for selection.

11. A non-transitory computer readable medium comprising instructions for providing a quantitatively-derived financing option for a consumer, the instructions, when executed by a hardware processor associated with the non-transitory computer readable medium, implement:
receiving, from the consumer, one or more first parameters;
retrieving, from a third party, one or more second parameters;
analyzing the first parameters based at least in part on the second parameters; and
based on the analyzing, presenting one or more options to the consumer.

12. The medium of claim 11, wherein the one or more first parameters comprise personal identifying information associated with the consumer.

13. The medium of claim 12, wherein the one or more first parameters comprises a search query.

14. The medium of claim 13, wherein the third party is a physical vehicle lot or a virtual vehicle lot.

15. The medium of claim 14, wherein the one or more second parameters comprise information associated with the third party.

16. The medium of claim 15, wherein the one or more second parameters are retrieved based on the search query.

17. The medium of claim 16, wherein the one or more options comprises a vehicle set of one or more automobiles.

18. The medium of claim 17, wherein the vehicle set is determined based on a quantitatively derived set of vehicle options based on the one or more first parameters and the one or more second parameters.

19. The medium of claim 18, wherein the quantitatively derived set of vehicle options is determined using real time predictive analytics.

20. A method for simultaneously providing multiple options for financing on multiple automobiles, with at least one computing device, the method comprising:
tracking data across multiple automobile types and multiple consumers;
using analytics of the tracked data, affecting pricing for financing across multiple financial institutions, multiple loan types; and
based on the affected pricing, adjusting criteria for financing across multiple loan types.
